(19) United States
(12) Patent Application Publication
(10) Pub. No.: US 2026/0221030 A1
(43) Pub. Date: Jul. 30, 2026

(54) DRIVING ASSISTANCE SYSTEM

(71) Applicant: HONDA MOTOR CO., LTD., Tokyo (JP)

(72) Inventors: Koji DAN, Saitama (JP); Toshiaki SEO, Saitama (JP); Takaya YAMAZAKI, Saitama (JP); Minoru HIGUCHI, Saitama (JP); Aya SASAKI, Saitama (JP); Shinichi MURAKAMI, Saitama (JP)

(21) Appl. No.: 19/149,098

(22) PCT Filed: Jan. 20, 2023
(86) PCT No.: PCT/JP2023/001695

§ 371 Date: Jul. 18, 2025

(51) Int. Cl. G08G 1/0967; B60R 1/24; B60R 1/26; G06V 20/20; G06V 20/54; G06V 20/58; G06V 20/59; G08G 1/16

(52) U.S. Cl. CPC G08G 1/0967; B60R 1/24; B60R 1/26; G06V 20/20; G06V 20/54; G06V 20/58; G06V 20/597; G08G 1/16; B60R 2300/307; B60R 2300/8093

(57) ABSTRACT

This driving assistance system comprises: an alarming object recognition unit that recognizes a participant who has a high degree of influence on safe driving as an alarming object; a display object setting unit that sets, as a display object, a preceding vehicle 2a recognized as the alarming object; a display control unit that emphasizes the presence of the preceding vehicle 2a set as the display object, on a front glass 51; and a driver recognition detection device that detects the presence or absence of the driver's recognition of surrounding traffic participants. The display object setting unit cancels the setting of the preceding vehicle 2a as the display object when the driver's recognition of the preceding vehicle 2a set as the display object is detected, and thereafter sets the preceding vehicle 2a as the display object again when the degree of influence of the preceding vehicle 2a increases.

### TECHNICAL FIELD

The present invention relates to a driving assistance system. More specifically, the present invention relates to a driving assistance system configured to recognize surrounding traffic participants having a high degree of influence on the safe driving of a subject vehicle, as caution targets, and encourages the driver of the subject vehicle to recognize such caution targets.

### BACKGROUND ART

In recent years, initiatives aimed at providing access to sustainable transportation systems that consider even the most vulnerable traffic participants have been gaining momentum. In order to realize such systems, intensive research and development efforts have been directed toward improving traffic safety and convenience through the development of driving assistance technologies that support driver recognition of surrounding conditions.

In the driving assistance technology disclosed in Patent Document 1, when a hazardous object that poses a potential collision risk with the subject vehicle is detected based on images of the surroundings of the subject vehicle, a first warning image highlighting the hazardous object is displayed on a display unit to prompt the driver of the subject vehicle to recognize the hazardous object.

### CITATION LIST

### Patent Document

Patent Document 1: Japanese Unexamined Patent Application, Publication No. 2010-191793

### DISCLOSURE OF THE INVENTION

### Problems to be Solved by the Invention

In the driving assistance technology disclosed in Patent Document 1, when the driver confirms the hazardous object after the first warning image is displayed, the display of the first warning image is terminated, and a second warning image, which is less visually emphasized than the first warning image, is displayed instead. In this manner, the conventional driving assistance technology terminates the display of the warning image in response to the driver's confirmation, thereby preventing the driver from feeling annoyed due to the continued display of the warning image. However, there are cases where the behavior of the hazardous object changes after being confirmed by the driver, potentially resulting in an increased risk of collision with the subject vehicle. Such a situation is not anticipated in Patent Document 1.

The present invention aims to provide a driving assistance system that allows the driver to recognize the presence of a caution target that may affect the safe driving of the subject vehicle, without causing annoyance to the driver, and thereby contributes to the development of a sustainable transportation system.

### Means for Solving the Problems

(1) A driving assistance system according to the present invention includes: an external environment recognition device configured to recognize traffic participants around a subject vehicle as surrounding traffic participants; a caution target recognition unit configured to recognize, as caution targets, traffic participants having a high degree of influence on the safe driving of the subject vehicle, among the traffic participants recognized as the surrounding traffic participants; a display target setting unit configured to set the traffic participants recognized as the caution targets, as display targets; a display control unit configured to execute the highlighting image processing to emphasize the presence of the display targets having been set as the display target, on a display unit provided at a position visible to the driver of the subject vehicle; and a driver recognition detection device configured to detect whether the driver recognizes the surrounding traffic participants. The display target setting unit is configured such that, when the driver's recognition of a specific traffic participant set as a display target is detected, the display target setting for the specific traffic participant is canceled, and when the degree of influence of the specific traffic participant subsequently increases, the specific traffic participant is set again as a display target.

(2) In this case, it is preferable that, after canceling the display target setting for the specific traffic participant, the display target setting unit sets the specific traffic participant again as a display target when the degree of influence of the specific traffic participant increases from the point in time when the display target setting was canceled or from the point in time when the driver's recognition was detected.

(3) In this case, it is preferable that the external environment recognition device acquires movement state information regarding the movement state of the surrounding traffic participants, and that the caution target recognition unit or the display target setting unit calculates the degree of influence, based on the movement state information.

(4) In this case, it is preferable that the driver recognition detection device includes an imaging device that captures the driver's face, and detects whether the driver recognizes the surrounding traffic participants, based on image data acquired by the imaging device.

(5) In this case, it is preferable that the caution target recognition unit or the display target setting unit detects or predicts the behavior of the surrounding traffic participants, based on the movement state information, and calculates the degree of influence, based on the results of such detection or prediction.

(6) In this case, it is preferable that the external environment recognition device acquires traffic environment information regarding the traffic environment surrounding the subject vehicle, and that the caution target recognition unit or the display target setting unit predicts the behavior of the surrounding traffic participants, based on the traffic environment information.

(7) In this case, it is preferable that the driving assistance system further includes a driver state acquisition device that acquires driver state information correlated with driving capability of the driver, and that the caution target recognition unit or the display target setting unit calculates the degree of influence, based on both the movement state information and the driver state information.

(8) In this case, it is preferable that, after the specific traffic participant is set as a display target, the display target setting unit cancels the display target setting for the specific traffic participant when a predetermined highlighting display period has elapsed or when the driver's recognition of the display target is detected. The highlighting display period is preferably set based on the degree of influence of the specific traffic participant.

(9) In this case, it is preferable that, when a plurality of traffic participants are recognized as caution targets, the display target setting unit sets, as display targets, the traffic participants who are extracted in descending order of the degree of influence within a range not exceeding a predetermined setting upper limit.

(10) In this case, it is preferable that the driving assistance system further includes a driver state acquisition device that acquires driver state information correlated with driving capability of the driver, and that the caution target recognition unit recognizes, as the caution targets, traffic participants whose degree of influence exceeds a predetermined degree-of-influence threshold, among the traffic participants recognized as the surrounding traffic participants. The degree-of-influence threshold is preferably set based on the driver state information.

(11) In this case, it is preferable that the display unit includes a front display unit that displays an image in front of the subject vehicle, and that the display control unit, in the highlighting image processing, defines a front display area on the front display unit where the image of the display target is displayed, and emphasizes the presence of the display target by superimposing a highlight image onto the front display area.

(12) In this case, it is preferable that the display unit includes a rear display unit that displays an image behind the subject vehicle, and that, in the highlighting image processing, the display control unit defines a rear display area on the rear display unit where the image of the display target is displayed, and emphasizes the presence of the display target by superimposing a highlight image onto the rear display area.

### Effects of the Invention

(1) In the present invention, the external environment recognition device is configured to recognize traffic participants around the subject vehicle as surrounding traffic participants; the caution target recognition unit recognizes traffic participants having a high degree of influence on the safe driving of the subject vehicle, as caution targets, among the traffic participants recognized as the surrounding traffic participants; the display target setting unit sets the traffic participants recognized as the caution targets, as display targets; the display control unit executes the highlighting image processing to emphasize the presence of the traffic participants having been set as the display targets, on a display unit visible to the driver. Therefore, according to the present invention, when a caution target having a high degree of influence on the safe driving of the subject vehicle exists around the subject vehicle and is set as a display target, the presence of the caution target (display target) is emphasized on the display unit through the highlighting image processing. As a result, the driver can easily recognize the presence of the caution target. In the present invention, when the driver's recognition of a specific traffic participant set as a display target is detected, the display target setting unit cancels the setting of this specific traffic participant as a display target. In response, the display control unit terminates the highlighting image processing for the specific traffic participant whose recognition by the driver has been detected. Thus, according to the present invention, it is possible to prevent the driver from feeling annoyed due to the highlighting image processing being continued even after the driver has recognized the traffic participant. Further, in the present invention, when the setting of the specific traffic participant as a display target is canceled, and then the degree of influence of this traffic participant increases, the display target setting unit sets the specific traffic participant again as a display target. In response, the display control unit restarts the highlighting image processing for the specific traffic participant whose degree of influence has increased. Therefore, according to the present invention, even after the driver has recognized the specific traffic participant, the highlighting image processing for the same participant is executed again in response to a change in circumstances, enabling the driver to recognize the presence of traffic participants who may affect safe driving of the subject vehicle, without causing annoyance, thereby supporting safe driving by the driver. This also contributes to the development of sustainable transportation systems.

(2) In the present invention, when the setting of a specific traffic participant as a display target is cancelled in response to the detection of the driver's recognition, then the degree of influence of this traffic participant increases from the point in time when the display setting was canceled or from the point in time when the driver's recognition was detected, the display target setting unit resets the specific traffic participant as a display target and resumes the highlighting image processing. Thus, according to the present invention, by determining whether the degree of influence has increased relative to the time the display target was canceled or the time the driver's recognition was detected, it is possible to appropriately determine whether the driver should be prompted to recognize the same traffic participant again, thereby supporting safe driving by the driver.

(3) In the present invention, the caution target recognition unit or the display target setting unit calculates the degree of influence, based on the movement state information regarding the movement state of the surrounding traffic participants. Accordingly, in the present invention, the degree of influence on the safe driving of the subject vehicle can be calculated with high accuracy by considering the movement state of the surrounding traffic participants, whereby the surrounding traffic participants that should definitely be recognized by the driver can be set as display targets.

(4) In the present invention, the driver recognition detection device detects whether the driver recognizes the surrounding traffic participants, based on the image data of the driver's face, thereby enabling detection of whether the driver has recognized the surrounding traffic participants by visual observation.

(5) In the present invention, the caution target recognition unit or the display target setting unit detects or predicts the behavior of the surrounding traffic participants, based on the movement state information of the surrounding traffic participants, and calculates the degree of influence of each surrounding traffic participant, based on the result of such detection or prediction. Therefore, according to the present invention, the degree of influence can be accurately calculated by reflecting the detected or predicted behavior of the surrounding traffic participants, whereby the surrounding traffic participants that should definitely be recognized by the driver can be set as display targets.

(6) In the present invention, the caution target recognition unit or the display target setting unit predicts the behavior of the surrounding traffic participants, based on the traffic environment information regarding the traffic environment surrounding the subject vehicle. As a result, the behavior of the surrounding traffic participants can be predicted with high accuracy, whereby the degree of influence can be calculated with high accuracy. Therefore, according to the present invention, the surrounding traffic participants that should definitely be recognized by the driver can be appropriately set as display targets.

(7) In the present invention, the caution target recognition unit or the display target setting unit calculates the degree of influence, based on the movement state information and the driver state information, whereby the degree of influence can be calculated with high accuracy, reflecting the current driving capability of the driver of the subject vehicle. Therefore, according to the present invention, the surrounding traffic participants that should definitely be recognized by the driver can be appropriately set as display targets.

(8) In the present invention, when a specific traffic participant having been recognized as a caution target is set as a display target, and then either a predetermined highlighting display period has elapsed or the driver's recognition of the display target is detected, the display target setting unit cancels the display target setting and terminates the highlighting image processing. Accordingly, the present invention prevents the driver from feeling annoyed due to the highlighting image processing being continued over a prolonged period of time. Furthermore, in the present invention, the highlighting display period is set based on the degree of influence of the specific traffic participant, whereby the highlighting display period can be adjusted to an appropriate length, based on the degree of influence of the traffic participant.

(9) In the present invention, in a case where a plurality of traffic participants are recognized as caution targets, the display target setting unit sets the traffic participants Sequentially extracted in descending order of degree of influence within a range not exceeding a predetermined setting upper limit, as display targets. Thus, according to the present invention, even in a case where a plurality of traffic participants are recognized as caution targets, the highlighting image processing is not simultaneously executed on more traffic participants than the setting upper limit, thereby preventing the driver from feeling annoyed or confused.

(10) In the present invention, among the traffic participants having been recognized as the surrounding traffic participants, the traffic participants whose degree of influence exceeds a predetermined degree-of-influence threshold are recognized as caution targets by the caution target recognition unit, in which the degree-of-influence threshold is set based on the driver state information. As a result, the frequency of the highlighting image processing can be adjusted based on the driver's current condition, thereby supporting safe driving by the driver.

(11) In the present invention, in the highlighting image processing, the display control unit defines a front display area on the front display unit where an image of the display target is displayed, and emphasizes the presence of the display target by superimposing a highlight image onto the front display area. As a result, the driver can easily recognize the presence of a display target in front of the subject vehicle.

(12) In the present invention, in the highlighting image processing, the display control unit defines a rear display area on the rear display unit where an image of the display target is displayed, and emphasizes the presence of the display target by superimposing a highlight image onto the rear display area. As a result, the driver can easily recognize the presence of a display target behind the subject vehicle.

### BRIEF DESCRIPTION OF THE DRAWINGS

FIG. 1 is a schematic diagram illustrating the configuration of a driving assistance system and a vehicle equipped with the driving assistance system according to an embodiment of the present invention;

FIG. 2 is a diagram illustrating an example of the highlighting image processing in a front display unit;

FIG. 3 is a diagram illustrating an example of the highlighting image processing in an electronic rearview mirror that serves as a rear display unit;

FIG. 4 is a flowchart illustrating the specific procedure of the display/non-display setting processing in a display target setting unit (Part 1);

FIG. 5 is a flowchart illustrating the specific procedure of the display/non-display setting processing in the display target setting unit (Part 2);

FIG. 6 is a flowchart illustrating the specific procedure of the display/non-display setting processing in the display target setting unit (Part 3);

FIG. 7 is a flowchart illustrating the specific procedure of the display/non-display setting processing in the display target setting unit (Part 4);

FIG. 8 is a diagram illustrating an example of a caution target list stored in a storage region of the display target setting unit; and

FIG. 9 is a flowchart illustrating the specific procedure of the cancellation-flag update processing.

### PREFERRED MODE FOR CARRYING OUT THE INVENTION

Hereinafter, a driving assistance system according to one embodiment of the present invention will be described with reference to the drawings.

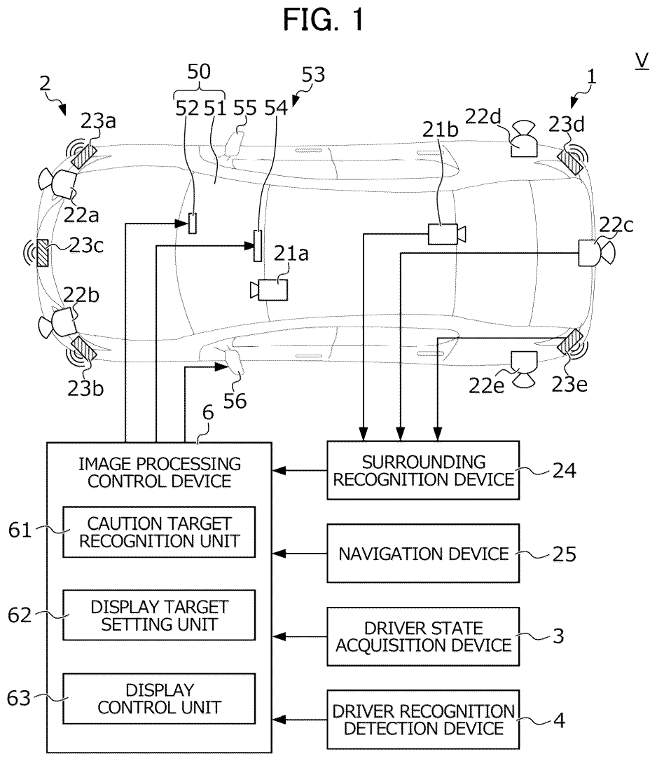

FIG. 1 is a schematic diagram illustrating the configuration of a driving assistance system 1 according to the present embodiment and a subject vehicle V (hereinafter also simply referred to as “vehicle V”) equipped with the driving assistance system 1. In the following description, the vehicle V is a so-called right-hand drive four-wheeled vehicle, in which the driver's seat is located on the right side in the vehicle width direction when viewed along the travelling direction; however, the present invention is not limited thereto. The vehicle may also be a so-called left-hand drive four-wheeled vehicle, in which the driver's seat is located on the left side in the vehicle width direction when viewed along the travelling direction.

In the driving assistance system 1, the traffic participants surrounding the vehicle V are recognized as surrounding traffic participants, and the traffic participants whose influence on the safe driving of the vehicle V is considered significant are recognized as caution targets, among one or more traffic participants recognized as the surrounding traffic participants. Furthermore, the highlighting image processing is executed to emphasize the presence of the one or more caution targets on a display unit visible to the driver of the vehicle V, thereby supporting the driver's recognition of the presence of the caution targets. In the following description, the driving assistance system 1 is installed on the vehicle V that is a four-wheeled automobile as illustrated in FIG. 1; however, the present invention is not limited thereto. The driving assistance system may also be installed on vehicles such as trucks or straddle-type vehicles, other than four-wheeled automobiles. When installed on a straddle-type vehicle among such vehicles, at least a portion of the driving assistance system may be integrated into a helmet worn by the rider, who is the driver. In the present embodiment, the term “traffic participant” refers to any entity that moves based on their own intention, such as vehicles or pedestrians.

The driving assistance system 1 includes: a vehicle-mounted external environment recognition device 2 that recognizes traffic participants (hereinafter also referred to as “surrounding traffic participants”) existing around the vehicle V (including those in front, behind, and on both sides in the travelling direction) and the traffic environment around the vehicle V; a driver state acquisition device 3 that acquires driver state information correlated with driving capability of the driver; a driver recognition detection device 4 that detects whether the driver recognizes the surrounding traffic participants; a front display unit 50 that displays an image of the front of the vehicle V; a rear display unit 53 that displays an image of the rear of the vehicle V; and an image processing control device 6 that executes the highlighting image processing on the display units 50 and 53, based on the recognition result from the vehicle-mounted external environment recognition device 2, the driver state information acquired by the driver state acquisition device 3, and the detection result from the driver recognition detection device 4.

The vehicle-mounted external environment recognition device 2 includes: a front camera unit 21a and a rear camera unit 21b; a plurality of (e.g., five) LiDAR units 22a, 22b, 22c, 22d, and 22e; a plurality of (e.g., five) radar units 23a, 23b, 23c, 23d, and 23e; a surrounding recognition device 24; and a navigation device 25.

The front camera unit 21a and the rear camera unit 21b are digital cameras using solid-state imaging elements such as CCD (Charge Coupled Devices) or CMOS (Complementary Metal Oxide Semiconductor), and capture images of the front and rear in the travelling direction of the vehicle V. These camera units 21a and 21b are mounted, for example, inside the cabin on the roof of the vehicle V, oriented toward the front and rear, respectively, in the travelling direction. Images captured by the camera units 21a and 21b are transmitted to the surrounding recognition device 24.

The LiDAR units 22a to 22e are Light Detection and Ranging (LiDAR) devices that detect objects around the vehicle V by measuring scattered light from laser pulses. The first LiDAR unit 22a is provided at the right front corner of the vehicle V when viewed in the travelling direction, and detects objects located slightly to the right in front of the vehicle V. The second LiDAR unit 22b is provided at the left front corner of the vehicle V when viewed in the travelling direction, and detects objects located slightly to the left in front of the vehicle V. The third LiDAR unit 22c is provided at the center in the vehicle-width direction at the rear of the vehicle V, and detects objects located behind the vehicle V. The fourth LiDAR unit 22d is provided at the rear side of the right side portion of the vehicle V, and detects objects located slightly to the rear on the right side of the vehicle V. The fifth LiDAR unit 22e is provided at the rear side of the left side portion of the vehicle V, and detects objects located slightly to the rear on the left side of the vehicle V. Detection signals from these LiDAR units 22a to 22e are transmitted to the surrounding recognition device 24.

The radar units 23a to 23e are millimeter-wave radars that detect objects around the vehicle V by measuring reflected waves from targets in response to millimeter-wave irradiation. The first radar unit 23a is provided at the right front corner of the vehicle V when viewed in the travelling direction, and detects objects located slightly to the right in front of the vehicle V. The second radar unit 23b is provided at the left front corner of the vehicle V when viewed in the travelling direction, and detects objects located slightly to the left in front of the vehicle V. The third radar unit 23c is provided at the center in the vehicle-width direction at the front of the vehicle V, and detects objects located in front of the vehicle V. The fourth radar unit 23d is provided at the right rear corner of the vehicle V when viewed in the travelling direction, and detects objects located slightly to the right behind the vehicle V. The fifth radar unit 23e is provided at the left rear corner of the vehicle V when viewed in the travelling direction, and detects objects located slightly to the left behind the vehicle V. Detection signals from these radar units 23a to 23e are transmitted to the surrounding recognition device 24.

The surrounding recognition device 24 executes the sensor fusion processing on the detection results from the camera units 21a and 21b, the LiDAR units 22a to 22e, the radar units 23a to 23e, and the like, thereby recognizing the surrounding traffic participants and the traffic environment around the vehicle V (that is, obstacles, roads, lanes, signs, signals, and the like), and also acquires the movement state information regarding each of the surrounding traffic participants, including type and movement state (that is, position, direction of movement, speed of movement, acceleration of movement, relative position with respect to the vehicle V, and relative speed with respect to the vehicle V), as well as the traffic environment information regarding the traffic environment. It is preferable that the surrounding recognition device 24 assigns a unique identification number to each of the recognized surrounding traffic participants such that each of the surrounding traffic participants can be identified by the image processing control device 6, which will be described later, and that the movement state information is associated with the identification numbers. The surrounding recognition device 24 transmits the acquired movement state information and traffic environment information to the driver recognition detection device 4 and the image processing control device 6, among others.

The navigation device 25 includes, for example, a GNSS receiver that determines the current position of the vehicle V, based on signals received from GNSS satellites, and a storage device that stores map information. The navigation device 25 transmits traffic environment information, such as the current position of the vehicle V and the types of surrounding roads, acquired using the GNSS receiver and storage device, to the image processing control device 6.

The driver state acquisition device 3 includes various devices that acquire the driver state information correlated with driving capability of the driver during driving. More specifically, the driver state acquisition device 3 includes, for example: an in-vehicle camera configured to detect the direction of the driver's gaze and whether the eyes are open while driving; a seatbelt sensor provided in a seatbelt worn by the driver and configured to detect the driver's pulse and whether the driver is breathing; a steering sensor provided in the steering wheel grasped by the driver and configured to detect the driver's skin potential; an in-vehicle microphone configured to detect whether conversation is occurring between the driver and a passenger; a wearable device configured to measure the driver's biometric information such as heart rate, blood pressure, and blood oxygen saturation; and a smartphone or the like configured to store the driver's schedule information. The driver state acquisition device 3 transmits the acquired driver state information to the image processing control device 6.

The driver recognition detection device 4 detects whether the driver recognizes the surrounding traffic participants. That is, the driver recognition detection device 4 detects whether the driver visually confirms the respective surrounding traffic participant, for each of the surrounding traffic participants recognized by the vehicle-mounted external environment recognition device 2. More specifically, the driver recognition detection device 4 includes the in-vehicle camera that captures an image of the driver's face, identifies the direction of the driver's gaze, based on the image data of the driver's face acquired by the in-vehicle camera, and compares the identified direction of gaze with the positions of the surrounding traffic participants specified based on the movement state information, thereby detecting whether the driver recognizes the surrounding traffic participants.

The front display unit 50 includes a windshield 51 located in front of the driver and a head-up display unit 52 that projects images onto the windshield 51. The windshield 51 displays images of the front of the vehicle V. The head-up display unit 52 superimposes a predetermined image onto a front display area defined on the windshield 51, in response to a command from the image processing control device 6, which will be described later.

The rear display unit 53 includes an electronic rearview mirror 54 that displays an image of the rear of the vehicle V, a left exterior rearview mirror unit 55 that displays an image of the rear left side of the vehicle V, and a right exterior rearview mirror unit 56 that displays an image of the rear right side of the vehicle V.

The electronic rearview mirror 54 is a display that displays, on its image display surface, an image of the rear of the vehicle V captured, for example, by the rear camera unit 21b, and is provided slightly above the driver's eye level within the interior of the vehicle V. The electronic rearview mirror 54 superimposes a predetermined image onto a rear display area defined on its image display surface, in response to a command from the image processing control device 6, which will be described later.

The left exterior rearview mirror unit 55 and the right exterior rearview mirror unit 56 are respectively provided on the left and right sides of the exterior of the vehicle V, as viewed from the driver. Each of the exterior rearview mirror units 55 and 56 includes: a mirror surface on which a mirror image of the rear side of the left or right side of the vehicle V is displayed; and an image display device configured to superimpose a predetermined image onto a rear display area defined on the mirror surface, in response to a command from the image processing control device 6, which will be described later.

The image processing control device 6 includes: a caution target recognition unit 61 configured to recognize traffic participants having a high degree of influence on the safe driving of the vehicle V, as caution targets, among the traffic participants having been recognized as the surrounding traffic participants by the vehicle-mounted external environment recognition device 2; a display target setting unit 62 configured to set one or more traffic participants having been recognized as caution targets by the caution target recognition unit 61, as either display targets or non-display targets; and a display control unit 63 configured to execute the highlighting image processing on the front display unit 50 and the rear display unit 53 in which the presence of one or more traffic participants set as display targets is emphasized. The functions of the caution target recognition unit 61, the display target setting unit 62, and the display control unit 63 will be described below in order.

The caution target recognition unit 61 recognizes traffic participants having a high degree of influence on the safe driving of the vehicle V, as caution targets, among one or more traffic participants recognized as the surrounding traffic participants by the vehicle-mounted external environment recognition device 2, based on the movement state information, the traffic state information, and the driver state information.

The caution target recognition unit 61 first calculates the degree of influence on the safe driving of the vehicle V for each of the traffic participants having been recognized as the surrounding traffic participants by the vehicle-mounted external environment recognition device 2, based on the movement state information, traffic state information, and driver state information. In the present embodiment, the degree of influence on the safe driving of the vehicle V is defined as a parameter that increases or decreases depending on the probability that the target traffic participant will come into contact with the vehicle V and the extent of the damage that the vehicle V may suffer due to the actions of the target traffic participant.

More specifically, the caution target recognition unit 61 detects or predicts dangerous behaviors, based on the movement state information, the traffic environment information, the driver state information, and the like, which may threaten the safe driving of the vehicle V by the target surrounding traffic participant, and calculates the degree of influence of the target surrounding traffic participant, based on the result of the detection or prediction of such dangerous behaviors. Here, the dangerous behaviors that may threaten the safe driving of the vehicle V include: a behavior in which the target surrounding traffic participant suddenly approaches the vehicle V; a behavior in which the target surrounding traffic participant suddenly blocks or crosses the planned travel path of the vehicle V; a behavior in which the target surrounding traffic participant suddenly decelerates on the planned travel path of the vehicle V; a behavior in which the target surrounding traffic participant passes in the vicinity of the vehicle V at a speed faster than that of the vehicle V; a behavior in which the target surrounding traffic participant follows the vehicle V at a short distance; and a behavior in which the target surrounding traffic participant provokes the driver of the vehicle V.

These surrounding traffic participants may exhibit the above-described dangerous behaviors due to changes in the surrounding traffic environment (for example, a reduction in the number of lanes or the presence of a merging point). Accordingly, it is preferable that the caution target recognition unit 61 predicts the dangerous behaviors of the target surrounding traffic participants, based not only on the movement state information but also on the traffic environment information.

Furthermore, the influence that the above-described dangerous behaviors of surrounding traffic participants have on the safe driving of the vehicle V varies depending on the state of the driver of the vehicle V. That is, when the recognition of the surrounding traffic participants by the driver of the vehicle V tends to be delayed, the influence on the safe driving of the vehicle V becomes greater due to the driver's delayed recognition. Accordingly, it is preferable that the caution target recognition unit 61 calculates the degree of influence of the target surrounding traffic participants, based not only on the movement state information and the traffic environment information but also on the driver state information.

The caution target recognition unit 61 calculates the degree of influence of each surrounding traffic participant, then compares the calculated degree of influence with a predetermined degree-of-influence threshold, thereby identifying the surrounding traffic participants who should be recognized as caution targets. That is, the caution target recognition unit 61 recognizes traffic participants whose degree of influence exceeds the degree-of-influence threshold, as caution target, among one or more surrounding traffic participants.

Here, the caution target recognition unit 61 may use the above-described degree-of-influence threshold as a fixed value, or may set the degree-of-influence threshold as a variable value that is updated sequentially depending on one or both of the traffic environment information and the driver state information. More specifically, for example, when it is determined that the driver of the vehicle V is under stress, based on the driver state information, the caution target recognition unit 61 may set the degree-of-influence threshold to a smaller value than when it is determined that the driver is not under stress. In this manner, as the level of the driver's stress increases, the caution target recognition unit 61 decreases the degree-of-influence threshold, thereby increasing the frequency of executing the highlighting image processing described later, allowing for more frequently prompting the driver to recognize the surrounding situation. In addition, for example, when it is determined that the surrounding traffic environment is prone to accidents, based on the traffic environment information (for example, a narrow road or an area near a merging point on a main road), the caution target recognition unit 61 may set the degree-of-influence threshold to a smaller value than when the traffic environment is determined to be unlikely to result in an accident. In this manner, as the surrounding traffic environment of the vehicle V becomes more accident-prone, the caution target recognition unit 61 decreases the degree-of-influence threshold, thereby increasing the frequency of executing the highlighting image processing, allowing for prompting the driver to more frequently recognize the surroundings.

The caution target recognition unit 61 transmits information to the display target setting unit 62 and the display control unit 63, the information including: the caution target recognition count that corresponds to the number of surrounding traffic participants recognized as caution targets; the unique identification number assigned to each surrounding traffic participant recognized as a caution target; and the degree of influence of each surrounding traffic participant recognized as a caution target.

The display control unit 63 executes the highlighting image processing on the front display unit 50 that displays an image of the front of the vehicle V, and on the rear display unit 53 that displays images of the rear and rear-side areas of the vehicle V, such that the front display unit 50 and the rear display unit 53 emphasize the presence of the surrounding traffic participants having been set as display targets through the processing executed by the display target setting unit 62, which will be described later.

First, the display control unit 63 calculates the positions of the surrounding traffic participants having been set as display targets by the display target setting unit 62, based on the movement state information. Then, based on the calculated positions of the display targets, the display control unit 63 determines whether the display target exists in front of the vehicle V, that is, whether the display target is displayed on the windshield 51 of the front display unit 50. In a case where the display target exists in front of the vehicle V, the display control unit 63 executes the highlighting image processing on the head-up display unit 52 of the front display unit 50 to emphasize the presence of the display target displayed on the windshield 51.

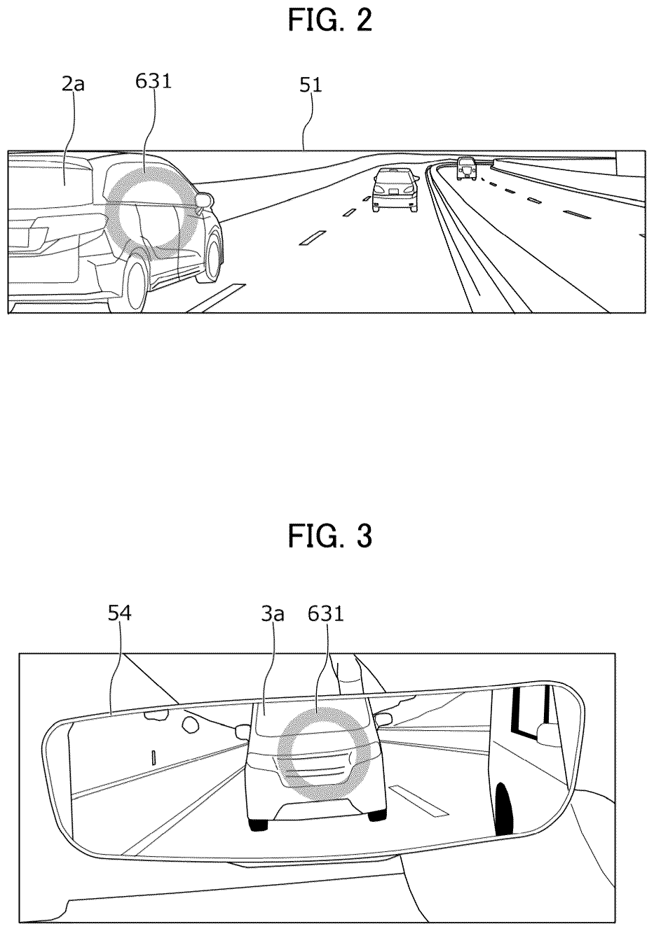

FIG. 2 is a diagram illustrating an example of the highlighting image processing executed on the front display unit 50. FIG. 2 illustrates a case in which a preceding vehicle 2a driving on the front-left side of the vehicle V is set as a display target, among the surrounding traffic participants of the vehicle V. In response to a determination that the preceding vehicle 2a may change lanes so as to block the front of the vehicle V, the caution target recognition unit 61 recognizes the preceding vehicle 2a as a caution target.

In the highlighting image processing on the front display unit 50, the display control unit 63 defines a front display area on the windshield 51 in front of the driver where the preceding vehicle 2a having been set as a display target is displayed—namely, in the example of FIG. 2, a portion of the windshield 51 through which the actual image of the preceding vehicle 2a is visible to the driver—and superimposes a highlight image 631 of a predetermined form onto the front display area to emphasize the presence of the preceding vehicle 2a.

FIG. 2 illustrates a case in which the highlight image 631 has a ring shape; however, the present invention is not limited thereto. The shape of the highlight image 631 may be a rectangular shape or another geometric shape, as long as the shape attracts the driver's attention. FIG. 2 also illustrates a case in which the highlight image 631 is slightly smaller than the preceding vehicle 2a; however, the present invention is not limited thereto. The highlight image 631 may be larger, as long as the image does not impair the driver's visibility, and may be varied in size depending on the size of the image of the display target being displayed. FIG. 2 illustrates a case in which the translucent highlight image 631 is superimposed onto the image of the preceding vehicle 2a; however, the present invention is not limited thereto. The highlight image may be non-translucent, as long as the shape thereof does not impair the driver's visibility. It is preferable that the color of the highlight image 631 is different from that of the preceding vehicle 2a and the surrounding background, and is a color that draws the driver's attention (e.g., green, yellow, red, etc.). The display control unit 63 may also cause the highlight image 631 to blink at a predetermined cycle, if necessary.

Returning to FIG. 1, in a case where a display target does not exist in front of the vehicle V, the display control unit 63 determines, based on the calculated position of the display target, whether the display target exists outside the blind spot to the rear or rear-side of the vehicle V, that is, whether the display target is displayed on either the image display surface of the electronic rearview mirror 54 or the mirror surface of the exterior rearview mirror units 55 and 56, which are included in the rear display unit 53. In a case where the display target exists outside the blind spot to the rear or rear-side of the vehicle V, the display control unit 63 executes the highlighting image processing on either the electronic rearview mirror 54 or the exterior rearview mirror units 55 and 56, which are included in the rear display unit 53, to emphasize the presence of the display target displayed on the image display surface or the mirror surface.

FIG. 3 is a diagram illustrating an example of the highlighting image processing executed on the electronic rearview mirror 54 of the rear display unit 53. FIG. 3 illustrates a case in which a following vehicle 3a driving behind the vehicle V is set as a display target, among the surrounding traffic participants of the vehicle V. Since the following vehicle 3a is following the vehicle V at an extremely short inter-vehicle distance, the caution target recognition unit 61 recognizes the following vehicle 3a as a caution target.

In the highlighting image processing on the rear display unit 53, the display control unit 63 defines a rear display area on the image display surface of the electronic rearview mirror 54 or the mirror surfaces of the exterior rearview mirror units 55 and 56 where the following vehicle 3a having been set as a display target is displayed—namely, in the example of FIG. 3, a portion of the image display surface of the electronic rearview mirror 54 through which the image of the following vehicle 3a is visible to the driver—and superimposes the highlight image 631 of the above-described form onto this rear display area to emphasize the presence of the following vehicle 3a.

The display control unit 63 executes the highlighting image processing on the front display unit 50 and the rear display unit 53 to emphasize the presence of the surrounding traffic participants having been set as display targets, through the procedures described above. Further, in a case where a surrounding traffic participant having been set as a display target is set as a non-display target while still being recognized as a caution target—namely, in a case where the display target setting for the surrounding traffic participant is canceled—the display control unit 63 terminates the highlighting image processing that had been executed up to that point. In a case where the surrounding traffic participant, which had been set as a display target, is no longer recognized as a caution target by the caution target recognition unit 61, the display control unit 63 also terminates the highlighting image processing that had been executed up to that point. When terminating the highlighting image processing in this manner, the display control unit 63 may either immediately erase the highlight image 631 that had been displayed on the front display unit 50 or the rear display unit 53, or may execute the gray-out image processing over a predetermined period of time, by gradually changing the form of the highlight image 631—namely, the shape, size, transparency, color, and the like—so as to gradually reduce the visual prominence.

The display target setting unit 62 sets one or more surrounding traffic participants, which have been recognized as caution targets by the caution target recognition unit 61, as either display targets or non-display targets. In a case where a surrounding traffic participant having been recognized as a caution target is set as a display target by the display target setting unit 62, the display control unit 63 executes the highlighting image processing for this surrounding traffic participant having been set as the display target, as described above. On the other hand, in a case where a surrounding traffic participant is set as a non-display target by the display target setting unit 62, even if this surrounding traffic participant is recognized as a caution target, the highlighting image processing is not executed for this surrounding traffic participant.

That is, the upper limit on the number of surrounding traffic participants that can be set simultaneously as display targets by the display target setting unit 62 (hereinafter referred to as the “display target setting upper limit”) is equal to the number of sessions of the highlighting image processing executed simultaneously by the display control unit 63, that is, the number of highlight images 631 displayed on the front display unit 50 and the rear display unit 53. Hereinafter, the display target setting upper limit is set to “2” and denoted as “Nmax.”

That is, the following describes a case where the display target setting unit 62 sets a plurality of surrounding traffic participants extracted within the range not exceeding the display target setting upper limit Nmax, as display targets, among the plurality of surrounding traffic participants recognized as the caution targets, and sets all the remaining participants as non-display targets; however, the present invention is not limited thereto. The display target setting upper limit Nmax may be set to “1” or to a value greater than “2.”

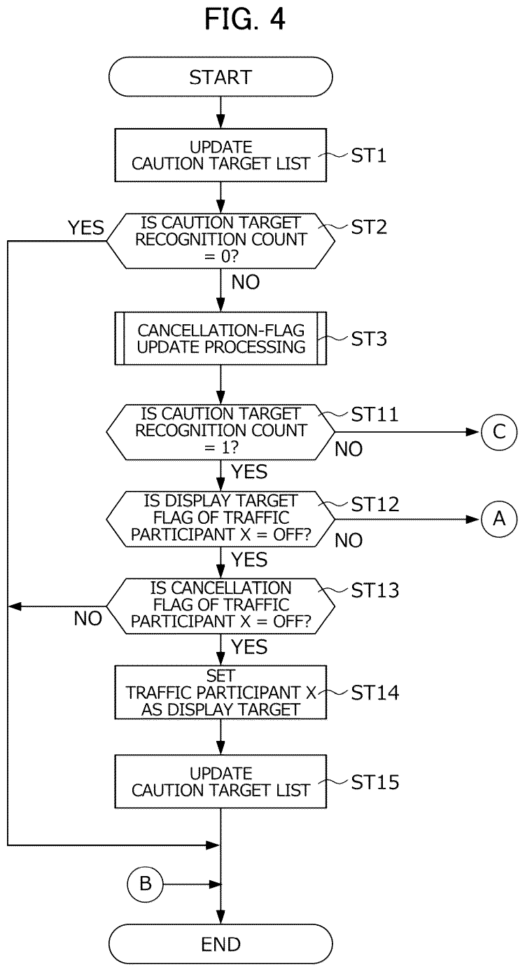

FIGS. 4 to 7 are flowcharts illustrating the specific procedures of the display/non-display setting processing executed by the display target setting unit 62. Here, the display/non-display setting processing refers to the processing in which surrounding traffic participants recognized as caution targets are set as either display targets or non-display targets, and this processing is repeatedly executed by the display target setting unit 62 at a predetermined control cycle. In the following description, when the display target setting unit 62 changes the surrounding traffic participant having been set as a display target to a non-display target, this is referred to as canceling the display target setting.

First, in Step ST1, the display target setting unit 62 updates a predetermined caution target list, based on the information transmitted from the caution target recognition unit 61, and proceeds to Step ST2.

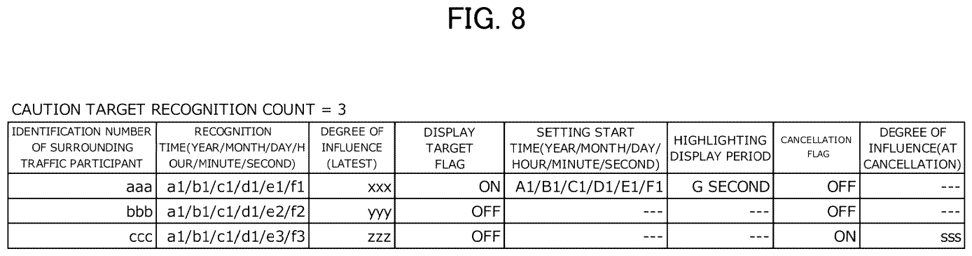

FIG. 8 is a diagram illustrating an example of the caution target list stored in a storage area of the display target setting unit 62. As illustrated in FIG. 8, the caution target list stores various pieces of information associated with unique identification numbers assigned to each of the surrounding traffic participants recognized as caution targets by the caution target recognition unit 61 in the current control cycle, in addition to the caution target recognition count in the current control cycle.

In the caution target list illustrated in FIG. 8, the field labeled “IDENTIFICATION NUMBER OF SURROUNDING TRAFFIC PARTICIPANT” stores the identification numbers of individual surrounding traffic participants having been recognized as caution targets by the caution target recognition unit 61 in the current control cycle.

In the caution target list illustrated in FIG. 8, the field labeled “RECOGNITION TIME” stores the time at which the target surrounding traffic participant (that is, the surrounding traffic participant associated with the identification number; the same applies hereinafter) was recognized as a caution target by the caution target recognition unit 61.

In the caution target list illustrated in FIG. 8, the field labeled “DEGREE OF INFLUENCE (LATEST)” stores the latest value of the degree of influence of the target surrounding traffic participant (that is, the value of the degree of influence calculated by the caution target recognition unit 61 in the current control cycle). In the present embodiment, an example is described in which the degree of influence of each surrounding traffic participant is calculated by the caution target recognition unit 61 in each control cycle; however, the present invention is not limited thereto. The degree of influence of each surrounding traffic participant recognized as a caution target by the caution target recognition unit 61 may instead be calculated by the display target setting unit 62 in each control cycle in accordance with the same procedure as that used by the caution target recognition unit 61.

In the caution target list illustrated in FIG. 8, the field labeled “DISPLAY TARGET FLAG” stores the status of a display target flag defined for each of the target surrounding traffic participants. This display target flag is a flag that explicitly indicates that the display target setting unit 62 has set the corresponding surrounding traffic participant as a display target, and is initially set to “OFF” when the traffic participant is first recognized as a caution target by the caution target recognition unit 61. As will be described later, in a case where the display target setting unit 62 sets a surrounding traffic participant, which has been recognized as a caution target, as a display target, the status of the display target flag associated with that surrounding traffic participant is set to “ON”. On the other hand, in a case where the display target setting unit 62 sets a surrounding traffic participant, which has been recognized as a caution target, as a non-display target, the status of the display target flag associated with that surrounding traffic participant is set to “OFF.”

In the caution target list illustrated in FIG. 8, the field labeled “SETTING START TIME” stores the time at which the display target setting unit 62 has set the corresponding surrounding traffic participant as a display target. As will be described later, in a case where the display target setting unit 62 sets a surrounding traffic participant, who has been recognized as a caution target, as a display target, the time at that moment is recorded as the setting start time.

In the caution target list illustrated in FIG. 8, the field labeled “HIGHLIGHTING DISPLAY PERIOD” stores the highlighting display period corresponding to the maximum duration for which the target surrounding traffic participant is to remain set as a display target. As will be described later, the display target setting unit 62 sets the highlighting display period in each control cycle, based on the latest degree of influence.

In the caution target list illustrated in FIG. 8, the field labeled “CANCELLATION FLAG” stores the status of a cancellation flag defined for each of the target surrounding traffic participants. This cancellation flag is a flag that explicitly indicates that the driver has recognized the surrounding traffic participant as a target, and is set to “OFF” when initially recognized as a caution target by the caution target recognition unit 61. As will be described later, in a case where the display target setting unit 62 cancels the display target setting for a surrounding traffic participant, the cancellation flag is set from “OFF” to “ON.” As will also be described later, in a case where a predetermined condition is satisfied after the cancellation flag has been set to “ON”, the display target setting unit 62 resets the cancellation flag from “ON” to “OFF”. Furthermore, as will be described later, the display target setting unit 62 does not set any surrounding traffic participant whose cancellation flag is set to “ON” as a display target.

In the caution target list illustrated in FIG. 8, the field labeled “DEGREE OF INFLUENCE (AT CANCELLATION)” stores the value of the degree of influence of the target surrounding traffic participant at the time when the display target setting for that participant is canceled. As will be described later, in a case where the display target setting unit 62 sets the cancellation flag from “OFF” to “ON,” the value of the degree of influence at that time is stored in the caution target list.

Returning to FIG. 4, in Step ST1, the display target setting unit 62 updates the caution target list, based on the information transmitted from the caution target recognition unit 61, and proceeds to Step ST2. More specifically, the display target setting unit 62 updates the field labeled “DEGREE OF INFLUENCE (LATEST)” in the caution target list, with the latest value. In addition, in a case where a new surrounding traffic participant is recognized as a caution target by the caution target recognition unit 61, the display target setting unit 62 adds information such as the identification number and the latest degree of influence of the new surrounding traffic participant to the caution target list, and increases the caution target recognition count by one. Further, in a case where a surrounding traffic participant that had previously been recognized as a caution target by the caution target recognition unit 61 is no longer recognized as the caution target by the caution target recognition unit 61, the display target setting unit 62 deletes all information relating to this surrounding traffic participant, being no longer recognized as the caution target, from the caution target list, and decreases the caution target recognition count by one.

Next, in Step ST2, the display target setting unit 62 refers to the caution target list and determines whether the caution target recognition count is equal to zero. If the determination result in Step ST2 is YES, that is, if the caution target recognition count is zero, the display target setting unit 62 does not execute the processing described below and terminates the display/non-display setting processing. If the determination result in Step ST2 is NO, that is, if the caution target recognition count is greater than zero, the display target setting unit 62 proceeds to Step ST3.

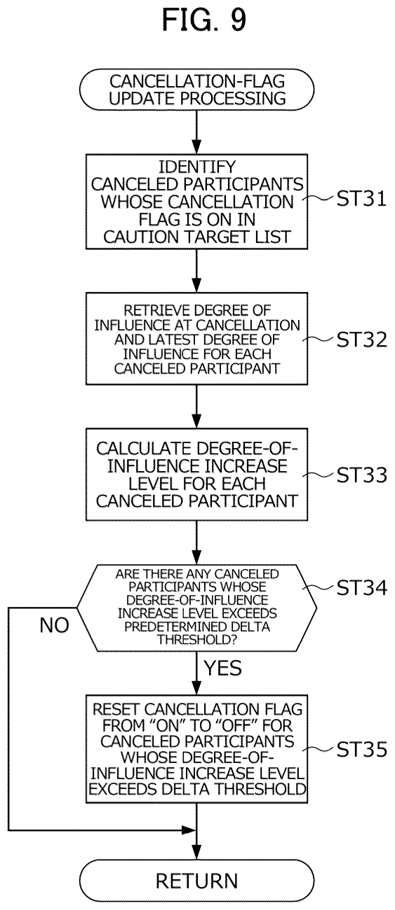

In Step ST3, the display target setting unit 62 executes the cancellation-flag update processing and proceeds to Step ST11. This cancellation-flag update processing updates the status of the cancellation flags defined in the caution target list, and details thereof will be described later with reference to FIG. 9.

In Step ST11, the display target setting unit 62 refers to the caution target list and determines whether the caution target recognition count is equal to “1”, which is less than the display target setting upper limit Nmax. If the determination result in Step ST11 is YES, that is, if the caution target recognition count is “1”, the display target setting unit 62 proceeds to Step ST12. In a case where only one surrounding traffic participant is recognized as a caution target, the display target setting unit 62 executes the processing in Steps ST12 to ST26, which will be described below. Accordingly, in the following description of the processing in Steps ST12 to ST26, the surrounding traffic participant recognized as a caution target is referred to as “traffic participant X” for ease of understanding.

First, in Step ST12, the display target setting unit 62 refers to the caution target list and determines whether the status of the display target flag for the traffic participant X is “OFF”. That is, in Step ST12, the display target setting unit 62 determines whether the traffic participant X was not set as a display target in the previous control cycle—in other words, whether the highlighting image processing for the traffic participant X was not executed in the previous control cycle. If the determination result in Step ST12 is YES, the display target setting unit 62 proceeds to Step ST13.

In Step ST13, the display target setting unit 62 refers to the caution target list and determines whether the status of the cancellation flag for the traffic participant X is “OFF.” If the determination result in Step ST13 is YES, the display target setting unit 62 proceeds to Step ST14.

In Step ST14, the display target setting unit 62 sets the traffic participant X as a display target and proceeds to Step ST15. In response to the setting of the traffic participant X as a display target by the display target setting unit 62 in this manner, the display control unit 63 starts the highlighting image processing for the traffic participant X. In Step ST15, the caution target list is updated and the display/non-display setting processing is terminated. More specifically, in response to the setting of the traffic participant X as a new display target in Step ST14, the display target setting unit 62 sets the display target flag for the traffic participant X in the caution target list from “OFF” to “ON”, and further stores the current time in the field labeled “SETTING START TIME” for the traffic participant X in the caution target list.

Here, as described above, the cancellation flag for the traffic participant X is initially set to “OFF” when the traffic participant X is first recognized as a caution target by the caution target recognition unit 61. Accordingly, in a case where only one participant (i.e., the traffic participant X) is recognized as a caution target by the caution target recognition unit 61, when the traffic participant X is recognized as a caution target by the caution target recognition unit 61, the display target setting unit 62 immediately sets the traffic participant X as a display target, and starts the highlighting image processing for the traffic participant X.

On the other hand, if the determination result in Step ST13 is NO, that is, if the status of the cancellation flag for the traffic participant X is “ON,” the display target setting unit 62 keeps the traffic participant X set as a non-display target and terminates the display/non-display setting processing. In this manner, the display target setting unit 62 does not set any surrounding traffic participant whose cancellation flag is set to “ON” as a display target.

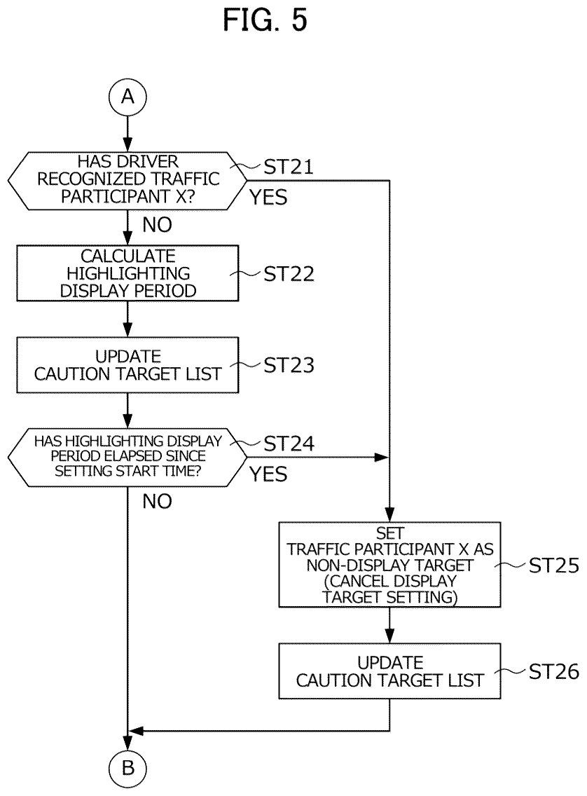

On the other hand, if the determination result in Step ST12 is NO, that is, if the traffic participant X was already set as a display target in the previous control cycle, the display target setting unit 62 proceeds to Step ST21 (see FIG. 5).

In Step ST21, the display target setting unit 62 refers to the detection result of the driver recognition detection device 4 and the caution target list, and determines whether the driver of the vehicle V has recognized the traffic participant X, which has been set as a display target, at any time from the setting start time until the present moment. If the determination result in Step ST21 is NO, the display target setting unit 62 proceeds to Step ST22.

In Step ST22, the display target setting unit 62 refers to the caution target list, acquires the latest degree of influence of the traffic participant X, which has been set as a display target, and calculates a highlighting display period for the traffic participant X, based on the acquired degree of influence. The processing then proceeds to Step ST23. In this Step ST22, it is preferable that the display target setting unit 62 calculates a longer highlighting display period as the degree of influence of the traffic participant X increases. In Step ST23, the display target setting unit 62 updates the caution target list and proceeds to Step ST24. More specifically, in response to the calculation of a new highlighting display period for the traffic participant X in Step ST22, the display target setting unit 62 stores the newly calculated highlighting display period in the field labeled “HIGHLIGHTING DISPLAY PERIOD” for the traffic participant X in the caution target list.

In Step ST24, the display target setting unit 62 refers to the caution list and determines whether the highlighting display period for the traffic participant X has elapsed from the setting start time to the present moment. If the determination result in Step ST24 is NO, the display target setting unit 62 maintains the display target setting for the traffic participant X and terminates the display/non-display setting processing. That is, if the determination result in Step ST24 is NO, the display target setting unit 62 terminates the display/non-display setting processing while keeping the status of the display target flag for the traffic participant X in the caution target list in the “ON” state.

If the determination result in Step ST21 is YES or the determination result in Step ST24 is YES—that is, after the traffic participant X has been set as a display target, the highlighting display period for the traffic participant X has elapsed or the driver's recognition of the traffic participant X has been detected-the display target setting unit 62 proceeds to Step ST25.

In Step ST25, the display target setting unit 62 sets the traffic participant X, which has been set as a display target, as a non-display target, and proceeds to Step ST26. In other words, the display target setting unit 62 cancels the display target setting for the traffic participant X and proceeds to Step ST26. In response to the cancellation of the display target setting for the traffic participant X by the display target setting unit 62 in this manner, the display control unit 63 terminates the highlighting image processing for the traffic participant X. In Step ST26, the display target setting unit 62 updates the caution target list and terminates the display/non-display setting processing. More specifically, in response to the cancellation of the display target setting for the traffic participant X in Step ST25, the display target setting unit 62 sets the display target flag for the traffic participant X in the caution target list from “ON” to “OFF”, sets the cancellation flag from “OFF” to “ON”, and stores the latest degree of influence in the field labeled “DEGREE OF INFLUENCE (AT CANCELLATION)”.

As described above, when the display target setting unit 62 cancels the display target setting for a surrounding traffic participant, the cancellation flag for that surrounding traffic participant is set from “OFF” to “ON”. On the other hand, as also described above, the display target setting unit 62 does not set any surrounding traffic participant whose cancellation flag is set to “ON” as a display target (see Step ST13 above). Accordingly, unless the cancellation flag is reset from “ON” to “OFF” through the cancellation-flag update processing, which will be described below with reference to FIG. 9, the display target setting unit 62 does not set the surrounding traffic participant again as a display target.

FIG. 9 is a flowchart illustrating the specific procedures of the cancellation-flag update processing. First, in Step ST31, the display target setting unit 62 refers to the caution target list, identifies all of the one or more surrounding traffic participants whose cancellation flags are set to “ON”, and proceeds to Step ST32. Hereinafter, the surrounding traffic participants in the caution target list, whose cancellation flags are set to “ON”, are also referred to as “canceled participants”.

In Step ST32, the display target setting unit 62 refers to the caution target list, acquires the degree of influence at cancellation and the latest degree of influence of each canceled participant, and proceeds to Step ST33.

In Step ST33, the display target setting unit 62 calculates the degree-of-influence increase level for each canceled participant, and proceeds to Step ST34. More specifically, the display target setting unit 62 calculates the degree-of-influence increase level for each canceled participant by subtracting the degree of influence at cancellation from the latest degree of influence acquired in Step ST32 (the degree-of-influence increase level=latest degree of influence−degree of influence at cancellation).

In Step ST34, the display target setting unit 62 determines whether there exists any canceled participant whose degree-of-influence increase level exceeds a predetermined positive delta threshold, among the one or more canceled participants identified in Step ST31. If the determination result in Step ST34 is NO, the display target setting unit 62 proceeds to Step ST11 (see FIG. 4) without updating the caution target list; if the determination result is YES, the display target setting unit 62 proceeds to Step ST35.

In Step ST35, the display target setting unit 62 updates the caution target list and proceeds to Step ST11. More specifically, the display target setting unit 62 resets the cancellation flag from “ON” to “OFF” for the canceled participants in the caution target list, whose degree-of-influence increase level exceeds the delta threshold.

Here, the function of the cancellation flag as such will be described using a case in which a traffic participant Y is recognized as a caution target by the caution target recognition unit 61.

In this case, when the traffic participant Y is recognized as a caution target, the display target setting unit 62 sets the traffic participant Y as a display target (see Step ST14), whereby the highlighting image processing is executed for the traffic participant Y. Subsequently, when the driver's recognition of the traffic participant Y, which has been set as a display target, is detected (see Step ST21), or when the highlighting display period has elapsed from the setting start time (see Step ST24), the display target setting unit 62 cancels the display target setting for the traffic participant Y (see Step ST25) and sets the cancellation flag for the traffic participant Y from “OFF” to “ON” (see Step ST26). As long as the cancellation flag for the traffic participant Y remains set to “ON”, the display target setting unit 62 does not set the traffic participant Y again as a display target (see Step ST13). Thereafter, when the degree of influence of the traffic participant Y, whose cancellation flag is set to “ON”, has increased to exceed a predetermined delta threshold from the point in time when the traffic participant Y was set as a non-display target or from the point in time when the driver's recognition of the traffic participant Y was detected (see Step ST34), the display target setting unit 62 resets the cancellation flag for the traffic participant Y from “ON” to “OFF” (see Step ST35). As a result, the traffic participant Y becomes eligible again to be set as a display target. Accordingly, at the time the cancellation flag for the traffic participant Y is reset from “ON” to “OFF”, if the total number of surrounding traffic participants currently set as display targets (hereinafter referred to as the “display target participant count”) is less than the display target setting upper limit Nmax, the display target setting unit 62 immediately sets the traffic participant Y again as a display target (see Step ST13), and the highlighting image processing for the traffic participant Y is executed again.

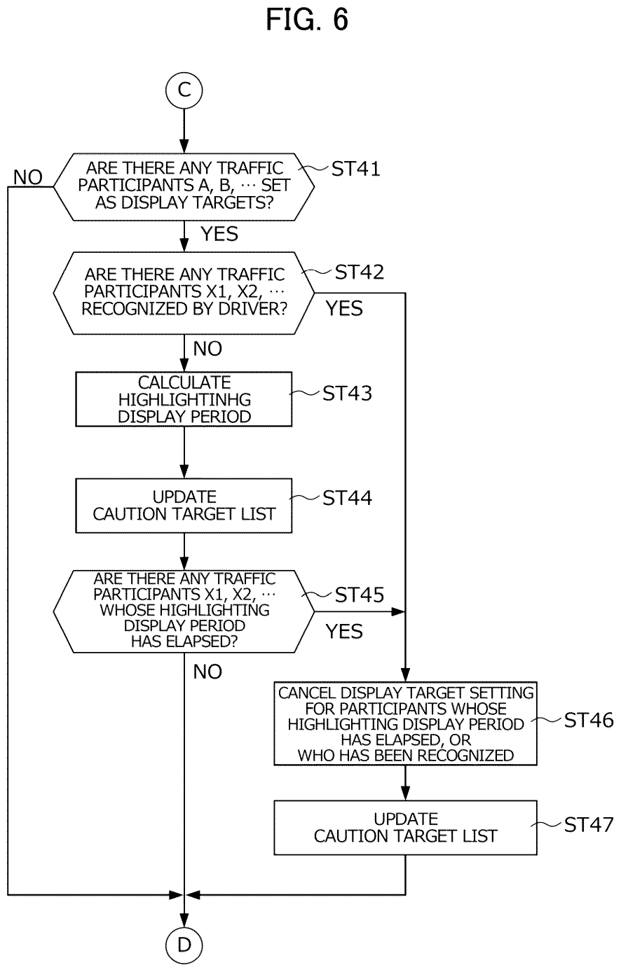

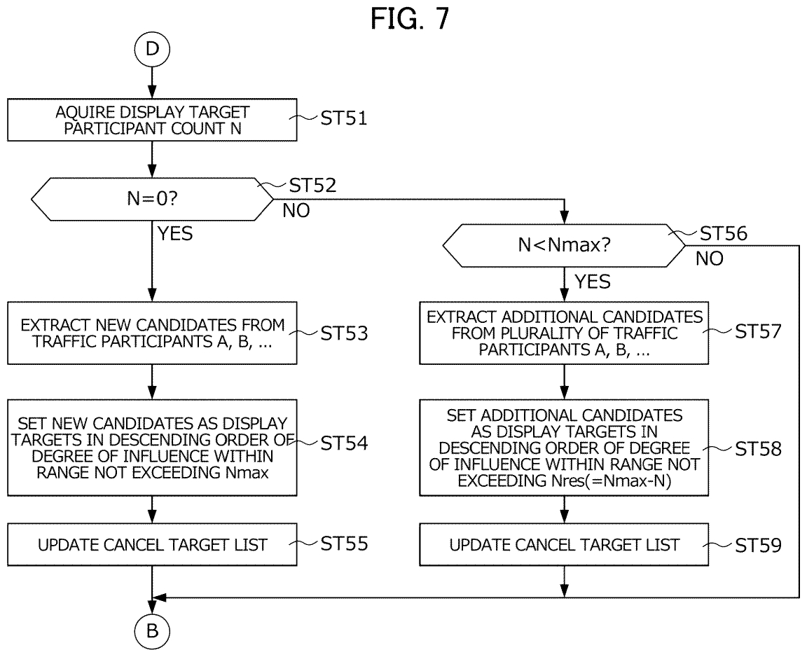

On the other hand, if the determination result in Step ST11 is NO, that is, if the caution target recognition count is “2” or more, the display target setting unit 62 proceeds to Step ST41 (see FIG. 6). In a case where two or more surrounding traffic participants are recognized as caution targets, the display target setting unit 62 executes the processing in Steps ST41 to ST59 as described below (see FIGS. 6 and 7). Accordingly, in the following description of the processing in Steps ST41 to ST59, the surrounding traffic participants having been recognized as caution targets, that is, the surrounding traffic participants listed in the caution target list, are referred to as “traffic participants A, B, . . . ” for ease of understanding.

First, in Step ST41, the display target setting unit 62 refers to the caution target list and determines whether there exists any participant that has already been set as display targets, among the plurality of traffic participants A, B, . . . . In other words, the display target setting unit 62 determines whether there exists any participant having the display target flag already set to “ON” in the caution target list, among the plurality of traffic participants A, B, . . . . If the determination result in Step ST41 is YES, the display target setting unit 62 proceeds to Step ST42.

In the following description of the processing in Steps ST42 to ST47, one or more traffic participants having already been set as display targets by the processing in Step ST41 are also referred to as the traffic participants X1, . . . , among the plurality of traffic participants A, B, . . . . In the processing in Steps ST42 to ST47, the display target setting unit 62 determines whether it is necessary to cancel the display target settings for the one or more traffic participants X1, . . . having been already set as display targets.

First, in Step ST42, the display target setting unit 62 refers to the detection result of the driver recognition detection device 4 and the caution target list, and determines whether there exists any traffic participant having been recognized by the driver during the period from the setting start time to the present moment, among the one or more traffic participants X1, . . . having been set as display targets. If the determination result in Step ST42 is NO, the display target setting unit 62 proceeds to Step ST43.

In Step ST43, the display target setting unit 62 refers to the caution target list, acquires the latest degree of influence of each of the one more traffic participants X1, . . . having been set as display targets, calculates the highlighting display period for each of the traffic participants X1, . . . based on the acquired degree of influence, and proceeds to Step ST44. In this Step ST43, as in Step ST22 described above, it is preferable that the display target setting unit 62 calculates a longer highlighting display period as the degree-of-influence increase level. In Step ST44, the display target setting unit 62 updates the caution target list and proceeds to Step ST45. More specifically, in response to the calculation of new highlighting display periods for each of the traffic participants X1, . . . in Step ST43, the display target setting unit 62 stores the newly calculated highlighting display periods in the field labeled “HIGHLIGHTING DISPLAY PERIOD” for each of the traffic participants X1, . . . in the caution target list.

In Step ST45, the display target setting unit 62 refers to the caution list and determines whether there exists any traffic participant having exceeded the highlighting display period during the period from the setting start time to the present moment, among the one or more traffic participants X1, . . . having been set as display targets.

If the determination result in Step ST42 is YES or the determination result in Step ST45 is YES—that is, if there exists any traffic participant having either exceeded the highlighting display period or having been recognized by the driver, among the one or more traffic participants X1, . . . having been set as display targets,—the display target setting unit 62 proceeds to Step ST46.

In Step ST46, the display target setting unit 62 cancels the display target setting for the traffic participants who have either exceeded the highlighting display period or have been recognized by the driver, among the one or more traffic participants X1 . . . having been set as display targets, and proceeds to Step ST47. In response to the cancellation of the display target setting by the display target setting unit 62, the display control unit 63 terminates the highlighting image processing for the participants whose display target setting has been canceled. In Step ST47, the display target setting unit 62 updates the caution target list and proceeds to Step ST51 (see FIG. 7). More specifically, in response to the cancellation of the display target status in Step ST46, the display target setting unit 62 sets the display target flag for the affected participants from “ON” to “OFF” for the participants whose display target setting in the caution target list has been canceled, sets the cancellation flag from “OFF” to “ON”, and records the latest degree of influence in the field labeled “DEGREE OF INFLUENCE (AT CANCELLATION)”.

If the determination result in Step ST41 is NO or the determination result in Step ST45 is NO, the display target setting unit 62 proceeds to Step ST51 (see FIG. 7). In the processing in Steps ST51 to ST59 described below, the display target setting unit 62 determines whether there exists any traffic participant to be newly set as a display target, among the plurality of traffic participants A, B, . . . having been recognized as caution targets.

First, in Step ST51, the display target setting unit 62 refers to the caution target list, acquires the display target participant count N, which is the total number of traffic participants currently set as display targets, and proceeds to Step ST52. More specifically, the display target setting unit 62 acquires the display target participant count N by counting the number of traffic participants whose display target flags are set to “ON” in the caution target list.

In Step ST52, the display target setting unit 62 determines whether the display target participant count N acquired in Step ST51 is “0”. If the determination result in Step ST52 is YES, that is, if none of the plurality of traffic participants A, B, . . . having been recognized as caution targets are currently set as display targets, the display target setting unit 62 proceeds to Step ST53.

In Step ST53, the display target setting unit 62 refers to the caution target list and extracts new candidates whose cancellation flags are set to “OFF”, among the plurality of traffic participants A, B, . . . , and proceeds to Step ST54. If no new candidates are extracted from among the plurality of traffic participants A, B, . . . in the processing in Step ST53, the display target setting unit 62 terminates the display/non-display setting processing without executing the processing in Steps ST54 to ST55.

In Step ST54, the display target setting unit 62 refers to the caution target list to acquire the latest degree of influence of each new candidate extracted in Step ST53, and sets, as display targets, the new candidates selected in descending order of degree of influence within the range not exceeding the display target setting upper limit Nmax, then proceeds to Step ST55. In response to the setting of one or more new candidates, extracted within the range not exceeding the display target setting upper limit Nmax, as display targets by the display target setting unit 62 in this manner (hereinafter, the one or more new candidates newly set as display targets in Step ST54 are also referred to as “newly assigned participants”), the display control unit 63 starts the highlighting image processing for these newly assigned participants. In Step ST55, the display target setting unit 62 updates the caution target list and terminates the display/non-display setting processing. More specifically, the display target setting unit 62 sets the display target flag from “OFF” to “ON” for each of the newly assigned participants in the caution target list, and stores the current time in the field labeled “SETTING START TIME” for each of the newly assigned participants in the caution target list.

On the other hand, if the determination result in Step ST52 is NO, that is, if at least one of the plurality of traffic participants A, B, . . . having been recognized as caution targets is set as a display target, the display target setting unit 62 proceeds to Step ST56.

In Step ST56, the display target setting unit 62 determines whether the display target participant count N, acquired in Step ST51, is less than the display target setting upper limit Nmax. If the determination result in Step ST56 is NO, that is, if the number of caution targets already set as display targets has reached the display target setting upper limit Nmax, the display target setting unit 62 terminates the display/non-display setting processing. That is, the display target setting unit 62 does not set more caution targets as display targets than the display target setting upper limit Nmax.

If the determination result in Step ST56 is YES, that is, if the display target participant count N is less than the display target setting upper limit Nmax and there is room to set new display targets, the display target setting unit 62 proceeds to Step ST57. In the processing in Steps ST57 to ST59 described below, the number Nres acquired by subtracting the display target participant count N from the display target setting upper limit Nmax (Nres=Nmax−N) is referred to as the remaining setting upper limit.

In Step ST57, the display target setting unit 62 refers to the caution target list, extracts additional candidates whose display target flags and cancellation flags are both set to “OFF”, from among the plurality of traffic participants A, B, . . . , and proceeds to Step ST58. If no additional candidates are extracted from among the plurality of traffic participants A, B, . . . in the processing in Step ST57, the display target setting unit 62 terminates the display/non-display setting processing without executing the processing in Steps ST58 to ST59.

In Step ST58, the display target setting unit 62 refers to the caution target list to acquire the latest degree of influence of each additional candidate extracted in Step ST57, and sets, as display targets, the additional candidates selected in descending order of degree of influence within the range not exceeding the remaining setting upper limit Nres, then proceeds to Step ST59. In response to the setting of one or more additional candidates, extracted within the range not exceeding the remaining setting upper limit Nres, as display targets by the display target setting unit 62 in this manner (hereinafter, the one or more additional candidates newly set as display targets in Step ST58 are also referred to as “additionally assigned participants”), the display control unit 63 starts the highlighting image processing for these additionally assigned participants. Further, in Step ST58, the display target setting unit 62 sets additional candidates as display targets within the range not exceeding the remaining setting upper limit Nres, such that the display target participant count N, including those already set as display targets, does not exceed the display target setting upper limit Nmax. In Step ST59, the display target setting unit 62 updates the caution target list and terminates the display/non-display setting processing. More specifically, the display target setting unit 62 sets the display target flag for each of the additionally assigned participants in the caution target list from “OFF” to “ON”, and stores the current time in the field labeled “SETTING START TIME” for each of the additionally assigned participants in the caution target list.

According to the driving assistance system 1 of the present embodiment, the following effects can be achieved.

(1) The vehicle-mounted external environment recognition device 2 recognizes traffic participants around the vehicle V as surrounding traffic participants; the caution target recognition unit 61 recognizes traffic participants having a high degree of influence on the safe driving of the vehicle V, as caution targets, among the traffic participants recognized as surrounding traffic participants; the display target setting unit 62 sets the traffic participants recognized as caution targets as display targets; and the display control unit 63 executes the highlighting image processing on the front display unit 50 and the rear display unit 53, which are visible to the driver, to emphasize the presence of the traffic participants having been set as display targets. Accordingly, in the driving assistance system 1, when a caution target having a high degree of influence on the safe driving of the vehicle V exists around the vehicle V and is set as a display target, the highlighting image processing is executed to emphasize the presence of the caution target (display target) on the front display unit 50 or the rear display unit 53, such that the driver can easily recognize the presence of the caution target. In the driving assistance system 1, when the driver's recognition of a specific traffic participant having been set as a display target is detected, the display target setting unit 62 cancels the display target setting for the specific traffic participant (see, for example, Step ST25 in FIG. 5 and Step ST46 in FIG. 6), and sets the cancellation flag for the specific traffic participant to “ON”. In response, the display control unit 63 terminates the highlighting image processing for the specific traffic participant whose recognition by the driver has been detected. Therefore, according to the driving assistance system 1, it is possible to prevent the driver from feeling annoyed due to the highlighting image processing being continued even after the driver has recognized the traffic participant. Furthermore, in the driving assistance system 1, after the display target setting for the specific traffic participant has been canceled as described above, when the degree of influence of the specific traffic participant increases, the display target setting unit 62 resets the cancellation flag for the specific traffic participant to “OFF” (see, for example, Step ST35 in FIG. 9), and subsequently sets the specific traffic participant again as a display target (see, for example, Step ST14 in FIG. 4, and Steps ST54 and ST58 in FIG. 7). In response, the display control unit 63 restarts the highlighting image processing for the specific traffic participant whose degree of influence has increased. Therefore, according to the driving assistance system 1, even after the driver has recognized the specific traffic participant, it is possible to make the driver recognize the presence of the specific traffic participant that may affect the safe driving of the vehicle V—without causing annoyance—by executing the highlighting image processing again in response to changes in subsequent conditions, thereby supporting safe driving by the driver. This also contributes to the development of a sustainable transportation system.

(2) In the driving assistance system 1, after the display target setting unit 62 cancels the display target setting for a specific traffic participant in response to the detection of the driver's recognition as described above, if the degree of influence of the specific traffic participant has increased from the point in time when the display target setting was canceled or from the point in time when the driver's recognition was detected, the display target setting unit 62 resets the cancellation flag for the specific traffic participant from “ON” to “OFF” (see Step ST35 in FIG. 9), and subsequently sets the specific traffic participant again as a display target (see, for example, Step ST14 in FIG. 4, and Steps ST54 and ST58 in FIG. 7), and restarts the highlighting image processing for the specific traffic participant. In this manner, according to the driving assistance system 1, by determining whether the degree of influence has increased from the point in time when the display target setting was canceled or from the point in time when the driver's recognition was detected, it is possible to appropriately determine whether the driver should be prompted to recognize the specific traffic participant again, thereby supporting safe driving by the driver.

(3) In the driving assistance system 1, the caution target recognition unit 61 or the display target setting unit 62 calculates the degree of influence, based on the movement state information regarding the movement state of the surrounding traffic participants. Accordingly, in the driving assistance system 1, the degree of influence on the safe driving of the vehicle V can be accurately calculated by taking into account the movement states of the surrounding traffic participants, such that the surrounding traffic participants that the driver should reliably recognize can be set as display targets.

(4) In the driving assistance system 1, the driver recognition detection device 4 is capable of detecting whether the driver has visually recognized the surrounding traffic participants by detecting whether the driver recognizes the surrounding traffic participants, based on image data of the driver's face.

(5) In the driving assistance system 1, the caution target recognition unit 61 or the display target setting unit 62 detects or predicts the behaviors of the surrounding traffic participants, based on the movement state information of the surrounding traffic participants, and calculates the degree of influence of the surrounding traffic participants, based on the results of such detection or prediction. Accordingly, in the driving assistance system 1, by reflecting the results of behavior detection or prediction of the surrounding traffic participants, the degree of influence can be accurately calculated, such that the surrounding traffic participants that the driver should reliably recognize can be set as display targets.

(6) In the driving assistance system 1, the caution target recognition unit 61 or the display target setting unit 62 predicts the behaviors of the surrounding traffic participants, based on the traffic environment information regarding the traffic environment around the vehicle V, thereby enabling accurate prediction of the behaviors of the surrounding traffic participants, and consequently, accurate calculation of the degree of influence thereof. Accordingly, in the driving assistance system 1, the surrounding traffic participants that the driver should reliably recognize can be set as display targets.

(7) In the driving assistance system 1, the caution target recognition unit 61 or the display target setting unit 62 calculates the degree of influence, based on the movement state information and the driver state information, thereby enabling accurate calculation of the degree of influence reflecting the current driving capability of the driver of the vehicle V. Accordingly, in the driving assistance system 1, the surrounding traffic participants that the driver should reliably recognize can be set as display targets.

(8) In the driving assistance system 1, after the display target setting unit 62 sets the specific traffic participant having been recognized as a caution target, as a display target, when a predetermined highlighting display period has elapsed or the driver's recognition of the display target is detected, the display target setting for the specific traffic participant is cancelled (see Step ST25 in FIG. 5 and Step ST46 in FIG. 6), and the highlighting image processing is terminated. Accordingly, in the driving assistance system 1, it is possible to prevent the driver from feeling annoyed due to the highlighting image processing being continuously executed for a long period of time. In the driving assistance system 1, the highlighting display period can also be set based on the degree of influence of the specific traffic participant, thereby allowing the highlighting display period to be set to an appropriate length in accordance with the degree of influence of the specific traffic participant.

(9) In the driving assistance system 1, in a case where a plurality of traffic participants are recognized as caution targets, the display target setting unit 62 sets, as display targets, the traffic participants extracted in descending order of degree of influence within a range not exceeding a predetermined display target setting upper limit Nmax (or the remaining setting upper limit Nres) (see Steps ST54 and ST58 in FIG. 7). Accordingly, according to the driving assistance system 1, even in a case where a plurality of traffic participants are recognized as caution targets, the highlighting image processing is not simultaneously executed for the number of traffic participants exceeding the display target setting upper limit Nmax, thereby preventing the driver from feeling annoyed or becoming confused.

(10) In the driving assistance system 1, the caution target recognition unit 61 recognizes the traffic participants whose degree of influence exceeds the degree-of-influence threshold, as caution targets, among the traffic participants recognized as surrounding traffic participants, and sets this degree-of-influence threshold, based on the driver state information. As a result, the frequency of executing the highlighting image processing can be adjusted in accordance with the driver's current condition, thereby supporting safe driving by the driver.

(11) In the driving assistance system 1, in the highlighting image processing, the display control unit 63 defines a front display area on the windshield 51 of the front display unit 50 to display an image of the display target, and emphasizes the presence of the display target by superimposing the highlight image 631 onto the front display area. As a result, the driver can easily recognize the presence of the display target in front of the vehicle V.

(12) In the driving assistance system 1, in the highlighting image processing, the display control unit 63 defines a rear display area on the rear display unit 53 where an image of the display target is displayed, and emphasizes the presence of the display target by superimposing the highlight image 631 onto the rear display area. As a result, the driver can easily recognize the presence of the display target behind the vehicle V.

While one embodiment of the present invention has been described above, the present invention is not limited thereto. Various modifications may be made to the detailed configuration within the scope of the spirit of the present invention.

For example, in the above-described embodiment, the vehicle-mounted external environment recognition device 2 recognizes the surrounding traffic participants and traffic environment around the vehicle V, based on the information acquired by the in-vehicle sensors such as the camera units 21a and 21b and the LiDAR units 22a to 22e, which move together with the vehicle V; however, the present invention is not limited thereto. The vehicle-mounted external environment recognition device 2 may recognize the surrounding traffic participants and the traffic environment around the vehicle V, based on the information acquired through inter-vehicle communication between the vehicle V and the surrounding traffic participants, or through wireless communication between the vehicle V and a traffic management server.

### EXPLANATION OF REFERENCE NUMERALS

V: vehicle (subject vehicle)
1: driving assistance system
2: vehicle-mounted external environment recognition device (external environment recognition device)
3: driver state acquisition device
4: driver recognition detection device
50: front display unit (display unit)
53: rear display unit (display unit)
6: image processing control device
61: caution target recognition unit
62: display target setting unit
63: display control unit

1. A driving assistance system, comprising:
an external environment recognizer configured to recognize traffic participants around a subject vehicle, as surrounding traffic participants;
a caution target recognizer configured to recognize a traffic participant having a high degree of influence on safe driving of the subject vehicle, as a caution target, among the traffic participants having been recognized as the surrounding traffic participants;
a display target setter configured to set the traffic participant having been recognized as the caution target, as a display target;
a display controller configured to execute highlighting image processing to emphasize a presence of the traffic participant having been set as the display target, on a display provided at a position visible to a driver of the subject vehicle; and
a driver recognition detector configured to detect whether the driver recognizes the surrounding traffic participants,
wherein, in a case where the driver's recognition of a specific traffic participant having been set as the display target is detected, the display target setter cancels setting of the display target for the specific traffic participant, and when a degree of influence of the specific traffic participant subsequently increases, the display target setter sets the specific traffic participant again as the display target.

2. The driving assistance system according to claim 1,
wherein, after canceling the setting of the display target for the specific traffic participant, when the degree of influence of the specific traffic participant has increased from a point in time when the setting of the display target was canceled or from a point in time when the driver's recognition was detected, the display target setter sets the specific traffic participant again as the display target.

3. The driving assistance system according to claim 1,
wherein the external environment recognizer acquires movement state information regarding the surrounding traffic participants, and
the caution target recognizer or the display target setter calculates the degree of influence, based on the movement state information.

4. The driving assistance system according to claim 1,
wherein the driver recognition detector includes an imager configured to capture the driver's face, and detects whether the driver recognizes the surrounding traffic participants, based on image data acquired by the imager.

5. The driving assistance system according to claim 3,
wherein the caution target recognizer or the display target setter detects or predicts a behavior of the surrounding traffic participants, based on the movement state information, and calculates the degree of influence of the surrounding traffic participants, based on a result of such detection or prediction.

6. The driving assistance system according to claim 5,
wherein the external environment recognizer acquires traffic environment information regarding a traffic environment around the subject vehicle, and
the caution target recognizer or the display target setter predicts the behavior of the surrounding traffic participants, based on the traffic environment information.

7. The driving assistance system according to claim 3, further comprising:
a driver state acquirer configured to acquire driver state information correlated with driving capability of the driver,
wherein the caution target recognizer or the display target setter calculates the degree of influence, based on the movement state information and the driver state information.

8. The driving assistance system according to claim 1,
wherein, after setting the specific traffic participant as the display target, when a predetermined highlighting display period has elapsed or the driver's recognition of the display target is detected, the display target setter cancels the setting of the display target for the specific traffic participant, and
the highlighting display period is set based on the degree of influence of the specific traffic participant.

9. The driving assistance system according to claim 1,
wherein, in a case where a plurality of traffic participants are recognized as the caution targets, the display target setter sets, as the display targets, the traffic participants extracted in descending order of degree of influence within a range not exceeding a predetermined setting upper limit.

10. The driving assistance system according to claim 1, further comprising:
a driver state acquirer configured to acquire driver state information correlated with driving capability of the driver,
wherein the caution target recognizer recognizes a traffic participant whose degree of influence exceeds a predetermined degree-of-influence threshold, as the caution target, among the traffic participants having been recognized as the surrounding traffic participants, and
the degree-of-influence threshold is set based on the driver state information.

11. The driving assistance system according to claim 1,
wherein the display includes a front display that displays an image of a front side of the subject vehicle, and
in the highlighting image processing, the display controller defines a front display area on the front display to display an image of the display target, and emphasizes a presence of the display target by superimposing a highlight image onto the front display area.

12. The driving assistance system according to claim 11,
wherein the display includes a rear display that displays an image of a rear side of the subject vehicle, and
in the highlighting image processing, the display controller defines a rear display area on the rear display to display an image of the display target, and emphasizes the presence of the display target by superimposing a highlight image onto the rear display area.
